(19) United States
(12) Patent Application Publication
(10) Pub. No.: US 2006/0178484 A1
(43) Pub. Date: Aug. 10, 2006

(54) Polyolefin grafted poly(vinyl alcohol) and process fro producing same

(75) Inventor: Vu A Dang, Bear, DE (US)

Correspondence Address: BASELL USA INC., INTELLECTUAL PROPERTY, 912 APPLETON ROAD, ELKTON, MD, 21921, US

(73) Assignee: Basell Poliolefine Italia S.p.A., Milan (IT)

(21) Appl. No.: 10/547,278

(22) PCT Filed: Mar. 1, 2004
(86) PCT No.: PCT/IB04/00526

§ 371 Date: Aug. 30, 2005

Related U.S. Application Data
(60) Provisional application No. 60/451,920, filed on Mar. 4, 2003.

(30) Foreign Application Priority Data
Mar. 18, 2003 (EP) 03100695.0

(51) Int. Cl. C08F 297/02

(52) U.S. Cl. 525/242

(57) ABSTRACT

A process for preparing an olefin polymer grafted poly(vinyl alcohol) polymer, in which an olefin polymer is first treated with a free radical polymerization initiator, a peroxidized olefin polymer material, or ionizing radiation, then grafted with a vinyl ester monomer to form an olefin polymer grafted poly(vinyl ester) polymer, and finally the vinyl ester moieties in the resulting grafted polymer are converted to vinyl alcohol moieties, at a temperature of from 25 to less than 100° C., in a mixed aromatic hydrocarbon/alkanol solvent system. The resulting olefin polymer grafted poly(vinyl alcohol) polymer has improved oxygen barrier properties.

This invention relates to an olefin polymer backbone grafted with poly(vinyl alcohol) and to a process for preparing same.

This invention relates to a process for preparing an olefin polymer backbone material grafted with poly(vinyl alcohol) polymer groups having utility as a barrier to gases, such as oxygen. This grafted polymer is particularly useful in the manufacture of films, sheets, composites for use as a packaging material and in the manufacture of plastic containers for foodstuffs, pharmaceuticals and industrial products.

Ethylene-poly(vinyl alcohol), is typically prepared by first polymerizing ethylene and vinyl acetate monomers using a free radical polymerization initiator to produce an ethylene-poly(vinyl acetate) copolymer and then converting the acetate moiety to an alcohol moiety by a slurry method at about 110° C. to produce a stable ethylene-poly(vinyl alcohol) copolymer. A melt process can also be used to convert the acetate moiety, but this method produces an alcohol moiety which is unstable. Another disadvantage of the melt process is that the copolymer is susceptible to degradation during the conversion of the acetate moiety to an alcohol.

Conventionally propylene has not been copolymerized with vinyl acetate. The propylene monomer only polymerizes in a predictable and reproducible fashion in the presence of Ziegler-Natta or metallocene catalysts. However, polymerizing propylene and vinyl acetate monomers in the presence of either Ziegler-Natta or metallocene catalysts produces a copolymer having a weight average molecular weight (Mw) too low to have any practical commercial significance. The monomers cannot be copolymerized using free radical polymerization because propylene does not effectively undergo polymerization via radical polymerization and free radicals poison the activity of both Ziegler-Natta and metallocene catalysts.

U.S. Pat. No. 5,140,074 discloses a method of making graft copolymers of olefin polymers by reacting a particulate olefin polymer with a vinyl monomer in the presence of a free radical initiator. The vinyl monomer may be any monomeric vinyl compound capable of being polymerized by free radicals, including vinyl esters of aliphatic carboxylic acids, such as vinyl acetate.

U.S. Pat. No. 5,411,994 discloses a method of making graft copolymers of olefin polymers by reacting a particulate olefin polymer with a vinyl monomer in ionizing radiation to initiate the reaction.

U.S. Pat. No. 5,369,168 discloses a single pass, melt reactive extrusion compatibilization of polyolefin and a polyvinyl alcohol. The polyolefin is first reacted with an unsaturated carboxylic acid or anhydride in the extruder to accomplish polyolefin grafting of the acid or acid anhydride, followed by reaction with the polyvinyl alcohol. The Examples teach an extrusion temperature of 200° C.

It is an object of the present invention to present a predictable and reproducible process for grafting an olefin polymer with polyvinyl alcohol to produce a graft polymer which can be used to produce packaging materials, such as films and containers, having improved oxygen barrier properties.

It is a feature of the present invention that the vinyl acetate monomer is graft polymerized onto a preformed olefin polymer backbone to form poly(vinyl alcohol) polymer groups rather than copolymerizing the vinyl acetate monomer with a C₂₋₆ alpha-olefin monomer.

Another feature of the present invention is that the vinyl acetate groups of the grafted olefin polymer/poly(vinyl acetate) copolymer are converted to vinyl alcohol groups using a non-stringent or mild slurry process in which relatively low temperatures (less than 100° C.) and a specified solvent system are employed to minimize polymer degradation.

The present invention provides an olefin polymer having poly(vinyl alcohol) polymer groups grafted thereon which can be used in the manufacture of articles having improved oxygen barrier properties.

In one aspect, the present invention relates to a process for preparing an olefin polymer grafted poly(vinyl alcohol) polymer, comprising the following steps:

(a) treating an olefin polymer material with (i) a free radical polymerization initiator compound, (ii) a peroxidized olefin polymer material, or (iii) ionizing radiation to produce a treated olefin polymer material;

(b) grafting the treated olefin polymer material with a vinyl ester monomer to form an olefin polymer having poly(vinyl ester) polymer groups grafted thereto, wherein steps a and b are conducted in an inert atmosphere; and

(c) converting from 40 to 100% of the vinyl ester groups of the poly(vinyl ester) polymer to vinyl alcohol groups to form poly(vinyl alcohol) polymer groups in a C₆₋₁₆ aromatic hydrocarbon/C₁₋₁₀ alkanol solvent system in a ratio of from 1:1 to 1:10 at a temperature of from 25° C. to less than 100° C.

In another aspect, the present invention relates to an olefin polymer grafted with poly(vinyl acetate) polymer groups prepared by a process comprising the following steps:

(a) treating an olefin polymer material with (i) a free radical polymerization initiator compound, (ii) a peroxidized olefin polymer material or (iii) ionizing radiation to produce a treated olefin polymer material;

(b) grafting the treated olefin polymer material with vinyl acetate monomer to form an olefin polymer having poly(vinyl acetate) polymer groups grafted thereto; and

(c) converting from 40 to 100% of the vinyl acetate groups of the poly(vinyl ester) polymer groups to vinyl alcohol groups to form poly(vinyl alcohol) polymer groups in a C₆₋₁₆ aromatic hydrocarbon/C₁₋₁₀ alkanol solvent system in a ratio of from 1:1 to 1:10 at a temperature of from 25° C. to 100° C.

In still another aspect, the present invention relates to a packaging material comprising a film or sheet of an olefin polymer grafted poly(vinyl alcohol) polymer or plastic container made from compositions comprising an olefin polymer grafted poly(vinyl alcohol) polymer wherein the olefin polymer grafted poly(vinyl alcohol) polymer provides improved oxygen barrier properties

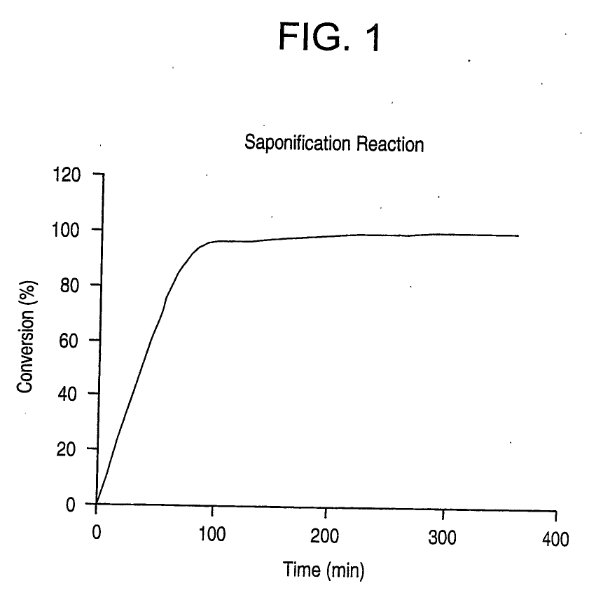

FIG. 1 is a graph which shows the kinetics of the vinyl acetate saponification reaction, as well as the time required to achieve maximum conversion of vinyl acetate moieties to vinyl alcohol moieties.

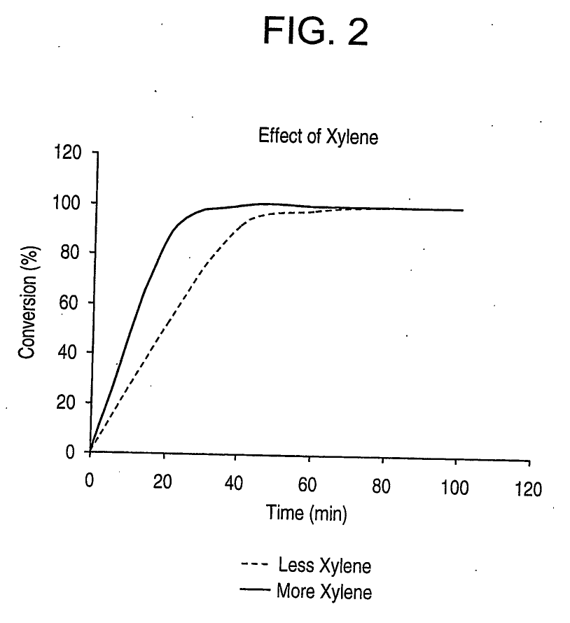

FIG. 2 is a graph which shows the effect of xylene on the reaction kinetics of the conversion of acetate moieties to alcohol moieties during the saponification reaction.

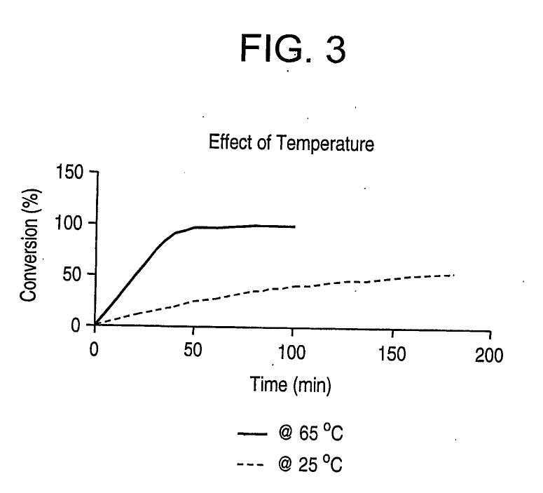

FIG. 3 is a graph which shows the effect of temperature on the reaction kinetics of the conversion of acetate moieties to alcohol moieties during the saponification reaction.

The present invention employs olefin polymers, rather than alpha-olefin monomers, as starting materials. The olefin polymer may illustratively be a propylene polymer, an ethylene polymer or a butene-1 polymer. Preferably it is a propylene or ethylene polymer, and most preferably a propylene polymer.

Suitable propylene polymers include:

(A) a crystalline homopolymer of propylene having an isotactic index greater than 80%, preferably about 90% to about 99.5%;

(B) a crystalline random copolymer of propylene and an olefin selected from the group consisting of ethylene and C₄-C₁₀ α-olefins, provided that when the olefin is ethylene, the maximum polymerized ethylene content is 10% by weight, preferably about 4%, and when the olefin is a C₄-C₁₀ α-olefin, the maximum polymerized content thereof is 20% by weight, preferably about 16%, the copolymer having an isotactic index greater than 60%, preferably at least 70%;

(C) a crystalline random terpolymer of propylene and two olefins selected from the group consisting of ethylene and C₄-C₈ α-olefins, provided that the maximum polymerized C₄-C₈ α-olefin content is 20% by weight, preferably about 16%, and when ethylene is one of the olefins, the maximum polymerized ethylene content is 5% by weight, preferably about 4%, the terpolymer having an isotactic index greater than 85%;

(D) an olefin polymer composition comprising:

(i) about 10 parts to about 60 parts by weight, preferably about 15 parts to about 55 parts, of a crystalline propylene homopolymer having an isotactic index at least 80%, preferably about 90 to about 99.5%, or a crystalline copolymer selected from the group consisting of (a) propylene and ethylene, (b) propylene, ethylene and a C₄-C₈ α-olefin, and (c) propylene and a C₄-C₈ α-olefin, the copolymer having a propylene content of more than 85% by weight, preferably about 90% to about 99%, and an isotactic index greater than 60%;
(ii) about 3 parts to about 25 parts by weight, preferably about 5 parts to about 20 parts, of a copolymer of ethylene and propylene or a C₄-C₈ α-olefin that is insoluble in xylene at ambient temperature; and
(iii) about 10 parts to about 80 parts by weight, preferably about 15 parts to about 65 parts, of an elastomeric copolymer selected from the group consisting of (a) ethylene and propylene, (b) ethylene, propylene, and a C₄-C₈ α-olefin, and (c) ethylene and a C₄-C₈ α-olefin, the copolymer optionally containing about 0.5% to about 10% by weight of a diene, and containing less than 70% by weight, preferably about 10% to about 60%, most preferably about 12% to about 55%, of ethylene and being soluble in xylene at ambient temperature and having an intrinsic viscosity of about 1.5 to about 4.0 dl/g;
   the total of (ii) and (iii), based on the total olefin polymer composition being from about 50% to about 90%, and the weight ratio of (ii)/(iii) being less than 0.4, preferably 0.1 to 0.3, wherein the composition is prepared by polymerization in at least two stages;
   (E) a thermoplastic olefin comprising:
(i) about 10% to about 60%, preferably about 20% to about 50%, of a propylene homopolymer having an isotactic index at least 80%, preferably 90-99.5% or a crystalline copolymer selected from the group consisting of (a) ethylene and propylene, (b) ethylene, propylene and a C₄-C₈ α-olefin, and (c) ethylene and a C₄-C₈ α-olefin, the copolymer having a propylene content greater than 85% and an isotactic index of greater than 60%;
(ii) about 20% to about 60%, preferably about 30% to about 50%, of an amorphous copolymer selected from the group consisting of (a) ethylene and propylene, (b) ethylene, propylene, and a C₄-C₈ α-olefin, and (c) ethylene and an α-olefin, the copolymer optionally containing about 0.5% to about 10% of a diene, and containing less than 70% ethylene and being soluble in xylene at ambient temperature; and
(iii) about 3% to about 40%, preferably about 10% to about 20%, of a copolymer of ethylene and propylene or an α-olefin that is insoluble in xylene at ambient temperature; and
   (F) mixtures thereof.

Suitable ethylene polymers include (a) homopolymers of ethylene, (b) random copolymers of ethylene and an alpha-olefin selected from the group consisting of C₃₋₁₀ α-olefins having a maximum polymerized α-olefin content of about 20 wt %, preferably a maximum of about 16 wt %, by weight, (c) random terpolymers of ethylene and the α-olefins, provided that the maximum polymerized α-olefin content is about 20 wt %, preferably the maximum is about 16 wt %, by weight, and (d) mixtures thereof. The C₃₋₁₀ α-olefins include the linear and branched α-olefins such as, for example, propylene, 1-butene, isobutylene, 1-pentene, 3-methyl-1-butene, 1-hexene, 3,4-dimethyl-1-butene, 1-heptene, 3-methyl-1-hexene, 1-octene and the like.

When the ethylene polymer is an ethylene homopolymer, it typically has a density of 0.89 g/cm³ or greater, and when the ethylene polymer is an ethylene copolymer with a C₃₋₁₀ α-olefin, it typically has a density of 0.91 g/cm³ or greater but less than 0.94 g/cm³. Suitable ethylene copolymers include ethylene/butene-1, ethylene/hexene-1, ethylene/octene-1 and ethylene/4-methyl-1-pentene. The ethylene copolymer can be a high density ethylene copolymer or a short chain branched linear low density ethylene copolymer (LLDPE), and the ethylene homopolymer can be a high density polyethylene (HDPE) or a low density polyethylene (LDPE). Typically the LLDPE and LDPE have densities of 0.910 g/cm³ or greater to less than 0.940 g/cm³ and the HDPE and high density ethylene copolymer have densities of greater than 0.940 g/cm³, usually 0.95 g/cm³ or greater. In general, ethylene polymer materials having a density from 0.89 to 0.97 g/cm³ are suitable for use in the practice of this invention. Preferably the ethylene polymers are LLDPE and HDPE having a density from 0.89 to 0.97 g/cm³.

When a butene-1 polymer is used as the olefin polymer of the present invention, the butene-1 polymer material is typically a normally solid, high molecular weight, predominantly crystalline butene-1 polymer material which can be:
(A) a homopolymer of butene-1;
(B) a copolymer or terpolymer of butene-1 with a non-butene α-olefin comonomer content of 1-15 mole %, preferably 1-10 mole %; and
(C) mixtures thereof.

Typically the non-butene α-olefin comonomer is ethylene, propylene, a C₅₋₈ alpha-olefin or mixtures thereof.

The useful polybutene-1 homo or copolymers can be isotactic or syndiotactic and have a melt flow rate (MFR) from about 0.5 to 150, preferably from about 0.5 to 100, and most preferably from 0.5 to 75 g/10 min.

These poly-1-butene polymers, their methods of preparation, and their properties are known in the art. An exemplary reference containing additional information on polybutylene-1 is U.S. Pat. No. 4,960,820.

Suitable polybutene-1 polymers can be obtained, for example, by Ziegler-Natta low-pressure polymerization of butene-1, e.g. by polymerizing butene-1 with catalysts of TiCl₃ or TiCl₃-AlCl₃ and Al(C₂H₅)₂Cl at temperatures of 10-100° C., preferably 20-40° C., e.g., according to the process described in DE-A-1,570,353. It can also be obtained, for example, by using TiCl₄—MgCl₂ catalysts. High melt indices are obtainable by further processing of the polymer by peroxide cracking or visbreaking, thermal treatment or irradiation to induce chain scissions leading to a higher MFR material.

Preferably, the polybutene-1 contains up to 15 mole % of copolymerized ethylene or propylene, but more preferably it is a homopolymer, for example, Polybutene PB0300 homopolymer marketed by Basell USA Inc. This polymer is a homopolymer with a MFR of 11 g/10 min. and a Mw of 270,000 daltons.

Preferably, the polybutene-1 homopolymer has a crystallinity of at least 55% by weight measured with wide-angle X-ray diffraction after 7 days. Typically the crystallinity is less than 70%, preferably less than 60%.

The first step of the process of the present invention comprises grafting a vinyl ester monomer onto an olefin polymer backbone. Typically the vinyl ester monomer is graft polymerized onto the olefin polymer backbone at a level from 10 to 90 parts per hundred (“pph”), preferably 15 to 60 pph. The vinyl ester monomer may be a vinyl ester of aromatic and unsaturated aliphatic carboxylic acids, including vinyl formate, vinyl acetate, vinyl chloroacetate, vinyl cyanoacetate, vinyl propionate and vinyl benzoate. Vinyl acetate is preferred.

Grafting of the vinyl ester monomer onto the olefin polymer material may be accomplished by methods described in U.S. Pat. No. 5,140,074. In general, grafting may be accomplished by reacting the olefin polymer material with vinyl ester monomer in the presence of a free radical initiator under substantially non-oxidizing conditions at a temperature of from about 60 to 125° C., preferably 80 to 120° C., to produce an olefin polymer grafted poly(vinyl ester) polymer.

The free radical initiator may be either (a) a chemical free radical polymerization initiator, or (b) a peroxidized olefin polymer material. The free radical initiator should preferably have a decomposition half-life at the grafting reaction temperature employed of about from 1 to 240, preferably from about 5 to 100, and most preferably 10 to 40 minutes. Suitable free radical initiators include organic peroxides, particularly those which generate alkoxy radicals. These organic peroxides include acyl peroxides, such as benzoyl and dibenzoyl peroxides, dialkyl and aralkyl peroxides such as di-tert-butyl peroxide, dicumyl peroxide, cumyl butyl peroxide, 1,1-di-tert-butylperoxy-3,5,5-trimethyl-cyclohexane, 2,5-dimethyl-2,5-di-tert-butyl peroxyhexane, and bis(alpha-tertbutylperoxy isopropyl benzene); peroxy esters, such as tert-butyl-peroxypivalate, tert-butyl perbenzoate, 2,5-dimethylhexyl 2,5-di(perbenzoate), tert-butyl di(perphthalate), tert-butylperoxy-2-ethyl hexanoate; and peroxy carbonates, such as di(ethylhexyl) peroxy dicarbonate, di(n-propyl) peroxy dicarbonate and di(4-tert-butylcyclohexyl) peroxy dicarbonate. Azo compounds, such as azobis isobutyronitrile, may also be used. Two or more initiators having the same or different half-lives may be employed.

The initiator, if a liquid peroxide at the decomposition temperature used, may be used neat or in solution. If a solid at the decomposition temperature used, it may be dissolved in a suitable liquid solvent. Peroxide initiators are available in hydrocarbon solutions at a concentration of about from 12.5 to 75 weight percent. Whether neat or in solution, the active concentration of the initiator per se should be about from 0.1 to 6.0 pph, preferably about 0.2 to 3.0 pph, to assure the generation of a sufficient number of free radical sites on and in the olefin polymer material.

A peroxidized olefin polymer material may also be used as the free radical initiator material, and may be prepared by irradiating an olefin polymer material in the absence of oxygen, adding a controlled amount of oxygen to the irradiated olefin material at a temperature of from 40 to 140° C. to produce an oxidized propylene polymer material containing greater than 1 mmol total peroxide per kilogram of propylene polymer material. U.S. Pat. No. 6,444,722, discloses the production of such peroxidized olefin polymer materials.

The absence of oxygen in grafting the olefin polymer material with a free radical initiator compound or a peroxidized olefin polymer material is typically accomplished by conducting the grafting reaction under an inert gas such as, for example, nitrogen, argon, helium and carbon dioxide.

Rather than using a free radical polymerization initiator, the olefin polymer material may also be grafted by irradiating the olefin polymer material with ionizing radiation to create free radical sites. The resulting olefin polymer material may then be treated with a vinyl monomer, such as vinyl acetate, to form an olefin polymer grafted poly(vinyl ester) polymer. Methods for preparing an olefin polymer grafted poly(vinyl ester) polymers via free radical polymerization using radiation initiation are disclosed in U.S. Pat. No. 5,411,994.

The irradiation should be performed in a substantially non-oxidizing (oxygen-free) environment to preclude reaction of the free radicals with oxygen. This may be accomplished by irradiation under vacuum or by replacing part or all of the air in the irradiation environment with an inert gas such as, for example, nitrogen, argon, helium and carbon dioxide.

Olefin polymer materials are normally free of oxygen immediately after the olefin monomer(s) is/are polymerized for form the olefin polymer material. Therefore, it is within the concept of the inventive process to immediately follow such olefin monomer polymerization and resulting olefin polymer workup steps (when the olefin polymer material is not exposed to air) with irradiation to create free radical sites in the polymer. However, in most situations the olefin polymer material is in particulate form and will have an oxygen content due to having been stored in an oxygen-containing atmosphere, such as air. Consequently, it is preferred to reduce the oxygen content of the olefin polymer material by introducing the olefin polymer material into a bed, which is then blown with nitrogen having an oxygen content of less than 0.05% by volume. The residence time of the olefin material in the bed should generally be at least 5 minutes for effective removal of oxygen from the interstices of the particles of the olefin polymer material.

Between this preparation step and the irradiation step, the prepared olefin polymer material should be maintained in an environment in which the active oxygen is less than about 15%, preferably less than 5%, in a gas conveyance system. In addition, the temperature of the olefin polymer material should be kept above the glass transition temperature of the amorphous fraction of the material, if any is present, because of the increase in temperature of the olefin polymer material which occurs during the irradiation step.

The active oxygen concentration of the irradiation environment should be less than about 5% by volume, more preferably less than about 1% by volume and most preferably less that 0.05% by volume.

The ionizing radiation should have sufficient energy to penetrate the olefin material to the extent necessary to create sufficient free radical sites on the polymer to permit subsequent reaction with the vinyl ester monomer. The ionizing radiation may be high energy electron or gamma radiation. An electron beam radiation emitted from an electron generator having an accelerating potential of from 500 to 4,000 kilovolts is preferred.

An ionizing dose of from 0.5 to 20 megarads (“Mrad”), delivered at a dose rate in the range of about 1 to about 10,000 Mrad per minute, is preferred. The term “rad” is usually defined as that quantity of ionizing radiation tat results in the absorption of 100 ergs of energy per gram of irradiated material, regardless of the radiation source.

After the olefin polymer material has been maintained in contact with the vinyl ester monomer for the appropriate period of time, the resulting graft copolymer, while still maintained in a substantially non-oxidizing environment, is treated, preferably by heating, so as to decompose any unreacted initiator, if any, and to deactivate substantially all of the residual free radicals therein. This substantially completely eliminates the possibility of any formation of peroxy radicals in the graft copolymer upon its exposure to air, which radicals can cause visbreaking or degradation of the polymer. Generally, heating at a temperature of at least about 110° C. for at least 5 minutes, preferably at least 120° C. for at least 20 minutes, is sufficient.

The vinyl ester moieties of the poly(vinyl ester) polymer groups of the grafted olefin polymer material are saponified to vinyl alcohol moieties by reaction with an alkali such as sodium or potassium alkoxide thereby forming poly(vinyl alcohol) polymer groups. Sodium methoxide is preferred.

The saponification reaction is performed using less stringent reaction temperatures than previously known and conventionally used. More specifically, 40-100%, preferably 50 to 100% and most preferably 55 to 100% of the vinyl ester groups in the poly(vinyl ester) polymer are converted to vinyl alcohol groups at a temperature of from 25 to less than 100° C., preferably 25 to 80° C. and most preferably 25 to 65° C. The lower reaction temperature ensures that the olefin polymer material is not melted, which minimizes the possibility of polymer degradation.

An important feature of the present invention is that a mixed solvent system comprising at least one aromatic hydrocarbon and at least one, linear or branched, alkanol is used to form a slurry of the grafted olefin polymer/poly(vinyl ester) polymer material. The aromatic hydrocarbon/alkanol ratio may range from 1:1 to 1:10, preferably from 1:2.5 to 1:5.2.

Suitable aromatic hydrocarbon solvents having 6 to 16 C atoms, preferably 6 to 12 C atoms, most preferably 6-8 C atoms. Typical aromatic hydrocarbon solvents include benzene, toluene, p-ethyltoluene, the xylenes, (i.e., ortho, meta or para), and mesitylene. The xylenes are most preferred.

Suitable linear or branched alkanols include C₁₋₁₀ alkanols, preferably methanol, ethanol, propanol and butanol.

All parts, percentages and ratios are by weight in this specification unless otherwise expressly noted. Ambient or room temperature as used herein means approximately 25° C.

### EXAMPLES

The following Examples provide more specific descriptions of specific embodiments of the present invention. These Examples are illustrative only, and should not be used to limit the scope of the appended claims. Unless otherwise specified, the properties of the polymer materials set forth in the following examples have been determined according to the following test methods:

Melt Flow Rate (“MFR”): ASTM D1238-230° C.; 2.16 kg

Oxygen Transmission Rate (“OTR”): ASTM D-3985

### Example 1

This example illustrates the preparation of a poly(vinyl ester)-grafted olefin polymer by using a liquid peroxide compound as the free radical initiator.

A jacketed reactor purged with nitrogen, equipped with a mechanical stirrer and operated under a nitrogen atmosphere was heated to 110° C. and 18,160 g propylene homopolymer having a melt flow rate (MFR) of 9 dg/min, commercially available from Basell USA Inc., was added to the reactor. Then 40 pph vinyl acetate and 2.7 pph Lupersol 11 t-butyl peroxy pivalate peroxide, commercially available from Akzo Nobel Chemicals Inc., were slowly added to the reactor at a rate of 1 pph/min. Upon completion of this addition, the reactor was maintained at 110° C. for 30 min. and then heated to 1400 and maintained at this temperature for 2 hours. The resulting polymer was then cooled and collected. The grafted polymer had a Mw over 100,000. The conversion vinyl acetate monomer to polymer was 92%.

### Example 2

This example illustrates the preparation of a poly(vinyl ester)-grafted olefin polymer using irradiation as the free radical initiator.

The propylene homopolymer of Example 1 was irradiated under a nitrogen atmosphere at a dose of 4 Mrad using electron beam radiation emitted from an electron generator having an accelerating potential of from 500 to 4,000 kilovolts. The irradiated polymer was collected under a nitrogen atmosphere in a vessel that had been purged with nitrogen and transferred to a one-gallon reactor kept continuously under nitrogen. The reactor was heated to 65° C. Then a mixture of 60 pph vinyl acetate, with respect to the amount of propylene homopolymer; 40 parts per million (“ppm”) N,N-dimethylhydroxylamine, with respect to the weight of vinyl acetate; and 49 ppm octadecylmercaptan, with respect to the weight of vinyl acetate, was added to the reactor at a rate of 1 pph/min. The reactor temperature was maintained at 65° C. for another 15 min. The reactor vent was then opened and a stream of nitrogen was introduced as the reactor was heated to 140° C. The reactor was held at 140° C. for one hour to remove any unreacted monomer and quench any unreacted or residual free radicals. The resulting grafted polymer was cooled and collected.

### Example 3

This example illustrates the preparation of a poly(vinyl ester)-grafted olefin polymer by using a polymeric peroxide as the free radical initiator.

The propylene homopolymer of Example 1 was irradiated under nitrogen at a dose of 0.5 Mrad using electron beam radiation emitted from an electron generator having an accelerating potential of from 500 to 4,000 kilovolts. The irradiated polymer was treated with 0.8% by volume oxygen at 140° C. for 60 min, held at this temperature for another 60 min. in the absence of oxygen and under nitrogen and then cooled and collected. The resulting irridiated, oxygenated polymer had a MFR of 131 dg/min.

The 2100 g oxygenated polymer prepared above was added to a reactor and heated to 140° C. under nitrogen. Then a mixture of 40 pph vinyl acetate (based on the amount of oxygenated polymer) and 250 ppm N,N-dimethylhydroxylamine (based on the amount of vinyl acetate) was added to the reactor at a rate of 0.75 pph/min under nitrogen. The reactor was maintained at 140° C. for another 60 minutes. The reactor vent was then opened and a stream of nitrogen was introduced as the reactor was heated to 140° C. The reactor was held at 140° C. for 60 min. to remove any unreacted monomer and to quench any unreacted or residual free radicals. The resulting grafted polymer was cooled and collected. The graft efficiency was 41%.

### Example 4

This example illustrated the conversion of vinyl acetate moieties to vinyl alcohol moieties. Certain amounts of the polypropylene-vinyl acetate graft polymer prepared in Example 1 was saponified to convert the vinyl acetate moieties to vinyl alcohol moieties in four different runs as follows.

For run IV-1, 500 g of the polypropylene-poly(vinyl acetate) graft copolymer was added to a mixture of xylene and methanol solvent system in a ratio of xylene:methanol of 1:5.2 by weight containing 5 mole % sodium methoxide (with respect to the amount of vinyl acetate present in the grafted polymer) heated at ambient temperature (25° C.). The reactor ingredients are stirred for 3 hours at ambient temperature, filtered and washed with 500 mL aliquots cold methanol (5° C.). Gas chromotographic analysis of the filtrate showed that 55% of the acetate moieties had been converted to vinyl alcohol moieties.

For run IV-2, 500 g of the polypropylene-poly(vinyl acetate) graft copolymer was added to a mixture of xylene and methanol solvent system in a ratio of xylene:methanol of 1:5.2 by weight containing 5 mole % sodium methoxide (with respect to the amount of vinyl acetate present in the grafted polymer) heated at 60° C. The reactor ingredients were heated to reflux at 65° C. for 3 hours, cooled, filtered and washed with 500 mL aliquots cold methanol (5° C.). Gas chromotographic analysis of the filtrate showed that 100% of the acetate moieties had been converted to vinyl alcohol moieties.

For run IV-3 (comparative), 500 g of the polypropylene-poly(vinyl acetate) graft copolymer was added to a mixture of xylene and methanol solvent system in a ratio of xylene:methanol of 1:148 using the procedure of run IV-2. Gas chromotographic analysis of the filtrate showed that 5% of the acetate moieties had been converted to vinyl alcohol moieties.

For run IV-4, 500 g of the polypropylene-poly(vinyl acetate) graft copolymer was added to a mixture of xylene and methanol solvent system in a ratio of xylene:methanol of 1:2.5 using the procedure of run IV-2. Gas chromotographic analysis of the filtrate showed that 100% of the acetate moieties had been converted to vinyl alcohol moieties.

Table 1 lists the reaction conditions and percent conversion achieved.

TABLE 1

| | Solvents | | | Temp. | Time | Conver- |
|---|---|---|---|---|---|---|
| Run | (Wt. Ratio) | MeOH | Base | (° C.) | (min) | sion |
| IV-1 | Xylene/MeOH | 10 | NaOMe | 25 | 180 | 55% |
| | (1:5.2) | | | | | |
| IV-2 | Xylene/MeOH | 10 | NaOMe | 65 | 180 | 100% |
| | (1:5.2) | | | | | |
| IV-3 | Xylene/MeOH | 10 | NaOMe | 65 | 180 | 5% |
| (comp) | (1:148) | | | | | |
| IV-4 | Xylene/MeOH | 10 | NaOMe | 65 | 180 | 100% |
| | (1:2.5) | | | | | |

Example 4 illustrates the importance of a mixed aromatic hydrocarbon/alkanol solvent system to the claimed process. Run IV-3, a comparative run, achieved only a 5% conversion when exceptionally high levels of methanol were used as the solvent mixture. The remaining runs illustrate that 100% conversion of the vinyl acetate moieties to vinyl alcohol moieties can be achieved when xylene/methanol is used as the solvent system, depending on the solvent ratio and reaction temperature.

### Example 5

The kinetics of the saponification of vinyl acetate moieties to vinyl alcohol moieties, the effect of the xylene concentration in the solvent mixture on saponification kinetics and the effect of temperature saponification kinetics are illustrated in the following experimental runs.

For run V-1, 500 g of the polypropylene-poly(vinyl acetate) graft copolymer of Example 1 was added to a mixture of xylene and methanol solvent system in a ratio of xylene:methanol of 1:4 by weight containing 5 mole % sodium methoxide (with respect to the amount of vinyl acetate present in the grafted polymer) which mixture had been heated at 60° C. The reactor ingredients were heated to reflux at 65° C. for 6 hours. Aliquots (approx. 5 mL each) of the reaction mixture were taken periodically over a period of 6 hours and each aliquot was subjected to gas chromotographic analysis to determine the concentration of methyl acetate formed. The conversion of acetate moieties to vinyl alcohol moieties was calculated. The results are shown in FIG. 1.

For run V-2, 500 g of the polypropylene-poly(vinyl acetate) graft copolymer of Example 1 was added to a mixture of xylene and methanol solvent system in a ratio of xylene:methanol of 1:5.2 by weight containing 5 mole % sodium methoxide (with respect to the amount of vinyl acetate present in the grafted polymer) which mixture have been heated to 60° C. The reactor ingredients were heated to reflux at 65° C. for 3 hours. Aliquots (5 mL each) of the reaction mixture were taken periodically over the 3 hour period or until there was no significant change in the formation of methyl acetate. Each aliquot was subjected to gas chromotographic analysis to determine the concentration of methyl acetate formed. The conversion of acetate moieties to vinyl alcohol moieties was calculated and are shown in FIGS. 2 and 3.

For run V-3, 500 g of the polypropylene-poly(vinyl acetate) graft copolymer of Example 1 was added to a mixture of xylene and methanol solvent system in a ratio of xylene:methanol of 1:2.5 by weight containing 5 mole % sodium methoxide (with respect to the amount of vinyl acetate present in the grafted polymer) and the procedure of run V-2 was followed. The results are shown in FIG. 2.

For run V-4, 500 g of the polypropylene-poly(vinyl acetate) graft copolymer of Example 1 was added to a mixture of xylene and methanol solvent system in a ratio of xylene:methanol of 1:5.2 by weight containing 5 mole % sodium methoxide (with respect to the amount of vinyl acetate present in the grafted polymer) heated to 25° C. The reaction mixture was then stirred at ambient temperature for 3 hrs. Aliquots (5 mL each) of the reaction mixture was taken periodically over a period of 3 hrs. Each aliquot was subjected to gas chromotographic analysis to determine the concentration of methyl acetate formed. The conversion of acetate moieties to vinyl alcohol moieties was calculated. The results are shown in FIG. 3.

### Example 6

This example illustrates the saponification of acetate moieties to alcohol moieties in films prepared from vinyl ester grafted propylene polymers.

For the control, 6 g of propylene homopolymer (“PP”) having a MFR of 5 g/10 min, commercially available from Basell USA Inc., was pressed and then made into a biaxially oriented, 0.03 mm (1.2 mil) thick film at 145° C. and the film was tested for oxygen barrier properties.

For runs VI-1 (comparative) and VI-4 (comparative), 6 g of the vinyl acetate grafted propylene polymer of Example 1 and Example 3, respectively, each were pressed and then made into biaxially oriented, 0.03 mm (1.2 mil) thick films at 145° C. and these films were tested for oxygen barrier properties.

For runs VI-3 and VI-6, 6 g of the vinyl acetate grafted propylene polymer of Example 1 and Example 3, respectively, each were pressed and then made into biaxially oriented, 0.03 mm (1.2 mil) thick films at 145° C. Each oriented film was immersed in a mixture of xylene:methanol of 1:5.2 by weight containing 5 mole % sodium methoxide (with respect to the amount of vinyl acetate present in the grafted polymer) which mixture had been heated at 60° C. The reactor ingredients were then heated to reflux at 65° C. for 15 hours, cooled, filtered, washed with 500 mL aliquots of cold methanol (5° C.) and subjected to infrared spectroscopy (“IR”). The IR results showed that all of the acetate moieties had been converted to alcohol moieties. These films were tested for oxygen barrier properties.

For runs VI-2 and VI-5, the ingredients VI-3 and VI-6, respectively, and the procedure of run VI-3 were used except the reactor ingredients were heated to reflux at 65° C. for 7 hours instead of 15 hours. The IR results showed that the acetate moieties had only been partially converted to alcohol moieties. These films were tested for oxygen barrier properties.

For run VI-7, 350 g of the polypropylene-poly(vinyl acetate) graft copolymer of Example 3 was added to a mixture of xylene and methanol solvent system in a ratio of xylene:methanol of 1:4 by weight containing 5 mole % sodium methoxide (with respect to the amount of vinyl acetate present in the grafted polymer) which mixture had been heated to 60° C. The reactor ingredients were then heated to reflux for 3 hours, filtered and washed with 500 mL aliquots of cold methanol (5° C.). Gas chromotographic analysis of the filtrate showed that 100% of the acetate moieties had been converted to vinyl alcohol moieties. The resulting polymer was pressed and made into a biaxially oriented, 0.03 mm (1.2 mil) thick film.

Table 2 lists the barrier properties of these film samples:

TABLE 2

| | | | | OTR, |
|---|---|---|---|---|
| | | | | cc/m²/mm/24 hr |
| Run | PVAc, pph | Initiator | Hydrolysis | (cc/m²/mil/24 hr) |
| Control | PP, 100 parts | — | — | 46.61 (1835) |
| VI-1 | 40 | Liquid | None | 26.29 (1035) |
| VI-2 | 40 | Liquid | Partial | 25.50 (1004) |
| VI-3 | 40 | Liquid | Full | 6.858 (270) |
| VI-4 | 40 | Polymeric | None | 30.43 (1198) |
| VI-5 | 40 | Polymeric | Partial | 27.79 (1094) |
| VI-6 | 40 | Polymeric | Full | 10.92 (430) |
| VI-7 | 40 | Polymeric | Full | 20.73 (816)* |

*Film was prepared after saponification.

OTR (oxygen transmission rate) is a test that measures the oxygen barrier property of a polymer article according to ASTM D-3985. Low OTR mean less oxygen permeated through the polymer article tested.

The olefin polymer grafted poly(vinyl alcohol) polymer of the present invention has improved oxygen barrier properties. When the olefin polymer grafted poly(vinyl alcohol) polymer of this invention is used in the production of plastic containers and packaging materials the resulting containers and packaging materials have better stiffness than those prepared with ethylene-poly(vinyl alcohol) polymers.

Moreover the olefin polymer grafted poly(vinyl alcohol) polymer of this invention is a more internally compatible product and therefore provides a more homogeneous dispersion than is possible by mechanically blending an olefin polymer material, such as a polypropylene, polyethylene or polybutene-1 polymer, with a poly(vinyl alcohol) polymer. All other things being equal, a homogeneous dispersion tends to provide improved barrier properties.

Other features, advantages and embodiments of the invention disclosed herein will be readily apparent to those exercising ordinary skill after reading the foregoing disclosures. In this regard, while specific embodiments of the invention have been described in considerable detail, variations and modifications of these embodiments can be effected without departing from the spirit and scope of the invention as described and claimed.

1. A process for preparing an olefin polymer grafted poly(vinyl alcohol) polymer, comprising the following steps:
(a) treating an olefin polymer material with (i) a free radical polymerization initiator compound, (ii) a peroxidized olefin polymer material or (iii) ionizing radiation to produce a treated olefin polymer material;
(b) grafting the treated olefin polymer material with a vinyl ester monomer to form an olefin polymer-poly(vinyl ester) grafted polymer; wherein steps (a) and (b) are conducted in an inert atmosphere, and
(c) converting from 40 to 100% of the vinyl ester moieties in the resulting grafted polymer to vinyl alcohol moieties in a C₆₋₁₆ aromatic hydrocarbon/C₁₋₁₀ alkanol solvent system in a ratio of from 1:1 to 1:10 at a temperature of from 25 to less than 100° C.

2. The process of claim 1, wherein the olefin polymer material is a propylene polymer material, an ethylene polymer material or a butene-1 polymer material.

3. The process of claim 2, wherein the olefin polymer material is a propylene polymer material selected from the group consisting of:
(A) a crystalline homopolymer of propylene having an isotactic index greater than 80%;
(B) a crystalline random copolymer of propylene and an olefin selected from the group consisting of ethylene and C₄-C₁₀ α-olefins, provided that when the olefin is ethylene, the maximum polymerized ethylene content is 10% by weight, and when the olefin is a C₄-C₁₀ α-olefin, the maximum polymerized content thereof is 20% by weight, the copolymer having an isotactic index greater than 60%;
(C) a crystalline random terpolymer of propylene and two olefins selected from the group consisting of ethylene and C₄-C₈ α-olefins, provided that the maximum polymerized C₄-C₈ α-olefin content is 20% by weight, and when ethylene is one of the olefins, the maximum polymerized ethylene content is 5% by weight, the terpolymer having an isotactic index greater than 85%;
(D) an olefin polymer composition comprising:
(i) about 10 parts to about 60 parts by weight of a crystalline propylene homopolymer having an isotactic index at least 80%, or a crystalline copolymer selected from the group consisting of (a) propylene and ethylene, (b) propylene, ethylene and a C₄-C₈ α-olefin, and (c) propylene and a C₄-C₈ α-olefin, the copolymer having a propylene content of more than 85% by weight, and an isotactic index greater than 60%;
(ii) about 3 parts to about 25 parts by weight of a copolymer of ethylene and propylene or a C₄-C₈ α-olefin that is insoluble in xylene at ambient temperature; and
(iii) about 10 parts to about 80 parts by weight of an elastomeric copolymer selected from the group consisting of (a) ethylene and propylene, (b) ethylene, propylene, and a C₄-C₈ α-olefin, and (c) ethylene and a C₄-C₈ α-olefin, the copolymer optionally containing about 0.5% to about 10% by weight of a diene, and containing less than 70% by weight of ethylene and being soluble in xylene at ambient temperature and having an intrinsic viscosity of about 1.5 to about 4.0 dl/g;
the total of (ii) and (iii), based on the total olefin polymer composition being from about 50% to about 90%, and the weight ratio of (ii)/(iii) being less than 0.4, wherein the composition is prepared by polymerization in at least two stages;
(E) a thermoplastic olefin comprising:
(i) about 10% to about 60% of a propylene homopolymer having an isotactic index at least 80%, or a crystalline copolymer selected from the group consisting of (a) ethylene and propylene, (b) ethylene, propylene and a C₄-C₈ α-olefin, and (c) ethylene and a C₄-C₈ α-olefin, the copolymer having a propylene content greater than 85% and an isotactic index of greater than 60%;
(ii) about 20% to about 60% of an amorphous copolymer selected from the group consisting of (a) ethylene and propylene, (b) ethylene, propylene, and a C₄-C₈ α-olefin, and (c) ethylene and an α-olefin, the copolymer optionally containing about 0.5% to about 10% of a diene, and containing less than 70% ethylene and being soluble in xylene at ambient temperature; and
(iii) about 3% to about 40% of a copolymer of ethylene and propylene or an α-olefin that is insoluble in xylene at ambient temperature; and
(F) mixtures thereof.

4. The process of claim 1 wherein, in step (a), the olefin polymer material is treated with a free radical polymerization initiator.

5. The process of claim 1 wherein, in step (a), the olefin polymer material is treated with a peroxidized olefin polymer.

6. The process of claim 1 wherein, in step (b), the vinyl ester monomer is a vinyl ester of an aromatic carboxylic acid or a saturated aliphatic carboxylic acid.

7. The process of claim 5, wherein the vinyl ester monomer vinyl formate, vinyl acetate, vinyl chloroacetate, vinyl cyanoacetate, vinyl propionate, vinyl benzoate or mixtures thereof, and is grafted polymerized at a level from 10-90 parts per hundred (pph).

8. The process of claim 6, wherein the vinyl ester monomer is vinyl acetate.

9. The process of claim 1 wherein, in step (c), the vinyl ester groups are converted to vinyl alcohol groups at a temperature from 25 to 80° C.

10. The process of claim 9, wherein the vinyl ester groups are converted to vinyl alcohol groups at a temperature from 25 to 65° C.

11. The process of claim 1 wherein, in the C₆₋₁₆ aromatic hydrocarbon/C₁₋₁₀ alkanol solvent system of step (c), the aromatic hydrocarbon is benzene, toluene, p-ethyltoluene, o-xylene, m-xylene, p-xylene, mesitylene or mixtures thereof, and the alkanol is methanol, ethanol, propanol, linear or branched butanol or mixtures thereof.

12. The process of claim 11, wherein the solvent system is xylene/methanol in a ratio of from 1:2.5 to 1:5.2.

13. The process of claim 1 wherein, in step (c), the conversion of vinyl ester moieties into vinyl alcohol moieties is from 50 to 100%.

14. The process of claim 1 whereinm in step (a), the olefin polymer material irradiated under ionizing radiation.

15. An olefin polymer grafted poly(vinyl alcohol) polymer prepared by the process of claim 1.

16. An olefin polymer grafted poly(vinyl alcohol) polymer prepared by the process of claim 7.

17. A packaging material comprising an olefin polymer grafted poly(vinyl alcohol) polymer of claim 15.

18. A packaging material comprising the olefin polymer grafted poly(vinyl alcohol) polymer of claim 16.

19. A container comprising an olefin polymer grafted poly(vinyl alcohol) polymer prepared by the process of claim 1.

20. An article of manufacture comprising an olefin polymer grafted poly(vinyl alcohol) polymer prepared by the process of claim 1.
